(19) United States
(12) Patent Application Publication
(10) Pub. No.: US 2007/0039664 A1
(43) Pub. Date: Feb. 22, 2007

(54) Saw infeed system

(75) Inventor: Bradley Quick, Staatsburg, NY (US)

Correspondence Address: GEORGE O. SAILE, 28 DAVIS AVENUE, POUGHKEEPSIE, NY, 12603, US

(73) Assignee: James L. Taylor Manufacturing Co.

(21) Appl. No.: 11/199,329

(22) Filed: Aug. 8, 2005

(51) Int. Cl. B27B 1/00; B23Q 15/00; B23Q 16/00

(52) U.S. Cl. 144/356; 144/392

(57) ABSTRACT

An apparatus and method for a single operator to load and control the automatic infeeding of workpieces to a saw including the loading of a first workpiece from a nearby supply and placing it onto a moveable structure that that is raised to form a ramp and lowered to release the workpiece. The workpiece moves down the ramp and stops against a stop member located on the top surface of the moveable structure positioned above a first conveyor. The operator controls the lowering of the ramp structure thereupon releasing the workpiece to the first conveyor moving the workpiece transversely past a scanner, which discerns dimensional characteristics of the workpiece. A second conveyor feeds the workpiece into the saw.

### BACKGROUND OF THE INVENTION

(1) Technical Field

This invention relates generally to an infeed method and apparatus for conveying individual lengths of woodpieces to wood cutting equipment, and more particularly, to improving the loading of woodpieces onto a servo-driven belt conveyor.

(2) Description of the Prior Art

The following 5 documents relate to apparatus for infeeding articles onto a conveyor for transport.

U.S. Pat. No. 6,305,525 issued Oct. 23, 2001 to Miller et al. describes a pressureless infeed conveyor for establishing a spacing between articles on a conveyor having reciprocating carriages driven by a reversible servo-motor.

U.S. Pat. No. 6,199,463 issued Mar. 13, 2001 to Quick describes an apparatus and methodology for infeeding workpieces to a saw.

U.S. Pat. Nos. 5,368,080 issued Nov. 29, 1994 to Hamel describes an apparatus and related method for a board edging infeed optimization system.

U.S. Pat. No. 4,874,080 issued Oct. 17, 1989 to Wroblewski describes a conveyor a plurality of parts in a desired orientation in a single line as they are received from an aligning device.

U.S. Pat. No. 4,163,491 issued Aug. 7, 1979 to Rock, et al. shows a holddown mechanism for veneer clipper infeed conveyors.

In operations involving the sawing of wood in, for example, sawmills, or in processing for the production of furniture, several considerations are taken into account in cutting wood economically. These include the timing with which the wood is fed to gang saws, the safety of the workers who are responsible for loading the wood onto the conveyor, and the number of workers required for the operation. For efficient operation, modern wood machining systems require substantially continuous processing of relatively large volumes of wood. Accordingly, gang saws, and other machining apparatus, capable of operating at high sawing rates have been developed. In order to fully utilize the high sawing speeds, however, wood delivery systems must be capable of providing such apparatus with wood at the relatively rapid rate at which the machining apparatus is processing the wood.

Another important consideration is the optimal way in which an incoming piece of wood stock of irregular shape can be cut to reduce waste. Typically, a log is first cut lengthwise along a number of parallel, axial planes to yield a number of irregularly shaped planks sometimes referred to as “cants”. Cants cut from the same log all have the same length. However, the height (or width, when later placed flat on its broad side) of each cant will vary depending upon where on the diameter of the log the cut is made. Furthermore, the thickness of each plank will be determined by the spacing of saw blades, if the log is cut in a gang saw. Usually, when cutting planks or cants from the same log, the blades are set equidistant from each other so that the resulting planks all have the same thickness. While the thickness of each cant is therefore the same in this arrangement of the blades, the height of each cant, will vary depending upon the particular section of the log is cut. For example, cants which are cut from sections close to the center of the log, as in a circle, will be higher than those cut near its outer periphery. Moreover, the cants will generally taper in one direction corresponding the lessening diameter of the tree toward its top.

The prior art also provides movable clamping devices for clamping and positioning boards from below. However, these devices have the disadvantage of having high maintenance needs because the longitudinal feeding chains used to propel boards into the saws have to follow a complicated path around and below each clamping device, Another example is U.S. Pat. No. 6,199,463 B1 (Quick), hereby incorporated by reference in its entirety, also assigned to the present assignee, discloses an automated infeed system. Referring to FIGS. 1a and 1b, there is provided an apparatus for automatically infeeding workpieces 90 to a fixed arbor rip saw 170. The apparatus having a means for selecting one of a plurality of the workpieces 90 at an input station 110. A servo-driven friction belt system 123 is connected to the input station 110, and advances the workpiece under a pattern projection system (not shown). The projection system causes a pattern of lines to be projected onto the workpiece, the pattern corresponding to one of a plurality of patterns representing the blade configuration of the fixed arbor gang rip saw 170. Finally, there is a pinch roller system 161, 162 used for removing the workpiece from the friction belt system and moving the workpiece into the saw, while maintaining the workpiece's original orientation under the pattern. Also provided is a sensor for measuring the board width while moving on the servo-driven friction belt system, where the width is input to a computer controlling the friction belt system and which determines the optimum pattern. there are shown side and elevational views, respectively, of the automated infeed system

The present invention has been developed to provide a novel approach for mechanically and manually loading a first conveyor means with a workpiece to be released and conveyed past a scanning means for identifying the dimensional characteristics of the workpiece, and on to a second conveying means for feeding the workpiece into fixed arbor gang rip saws without the complications associated with prior art workpiece loading apparatus and methods. The disclosed apparatus together with its new method of application bring much needed improvements to wood cutting operations, as discussed more in details below.

### SUMMARY OF THE INVENTION

It is therefore an object of this invention to provide an improved apparatus for automated feeding of a workpiece to a fixed arbor gang rip saw.

It is another object of this invention to provide a manual loading system that is ergonomically efficient and safely situated for a single person to operate.

It is another object of this invention to provide an automated infeed system having a low labor cost by reducing the total operation to a single person.

It is still another object of this invention to provide an improved apparatus for optimizing the sawing of wood pieces.

It is yet another object of this invention to provide an apparatus and method for selecting and maintaining a board orientation for feeding of a gang rip saw.

It is still another object of the invention to provide an automated infeed system having a low cost simple method for selecting a board cutting pattern and advancing the board to a gang rip saw while maintaining a selected board orientation.

In accordance this the aforementioned objects, there is provided an apparatus for automatically infeeding workpieces to a saw, under control of a computer. A first workpiece is manually placed on a gravity roller conveyor then released to a first conveying means. The width of the first workpiece is measured, and the workpiece is advanced under a projected pattern, the pattern based on the workpiece width and on optomizing yield. An operator may select an alternative pattern by moving the workpiece under the alternative patterns. An operator may also skew the first workpiece. The first workpiece is submitted to the saw input while maintaining the desired skew.

### DESCRIPTION OF THE DRAWINGS

FIG. 1a is a plan view showing a sawing system of the prior art.

FIG. 1b is a side elevation view of the prior art sawing system.

FIG. 2 is a perspective view showing an overview of a manual loading apparatus for an automated infeed system of the invention.

FIG. 3 illustrates a side view of the manual loading apparatus' position according to the invention.

FIG. 5 illustrates a side view of the manual loading apparatus' release position according to the invention.

FIG. 6 illustrates a side view of the automated infeed system showing the manual loading apparatus' position according to the invention.

FIG. 7 is a side view of the pinch-roller subsystem according to the invention.

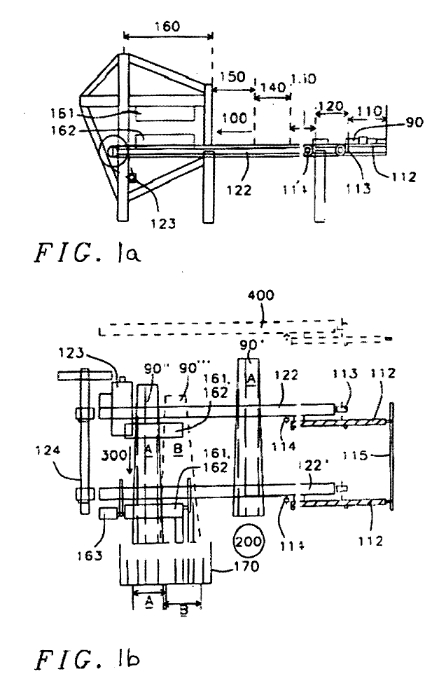

### DETAILED DESCRIPTION OF THE PREFERRED EMBODIMENT

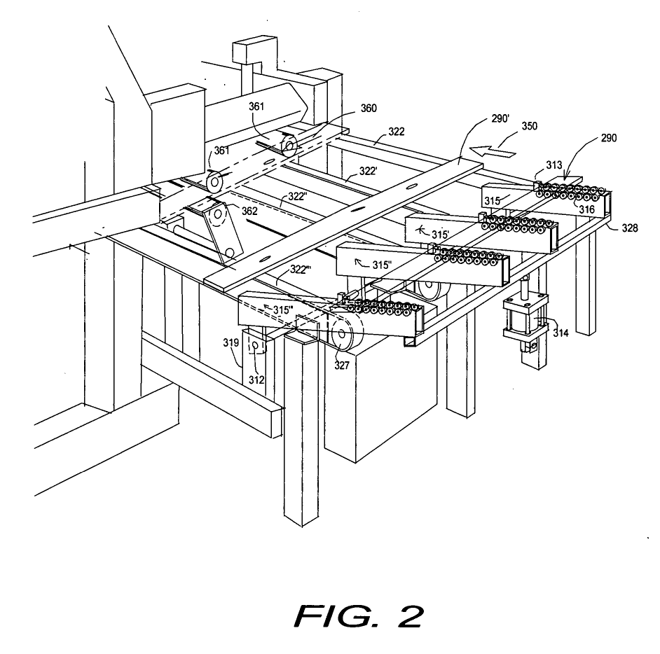

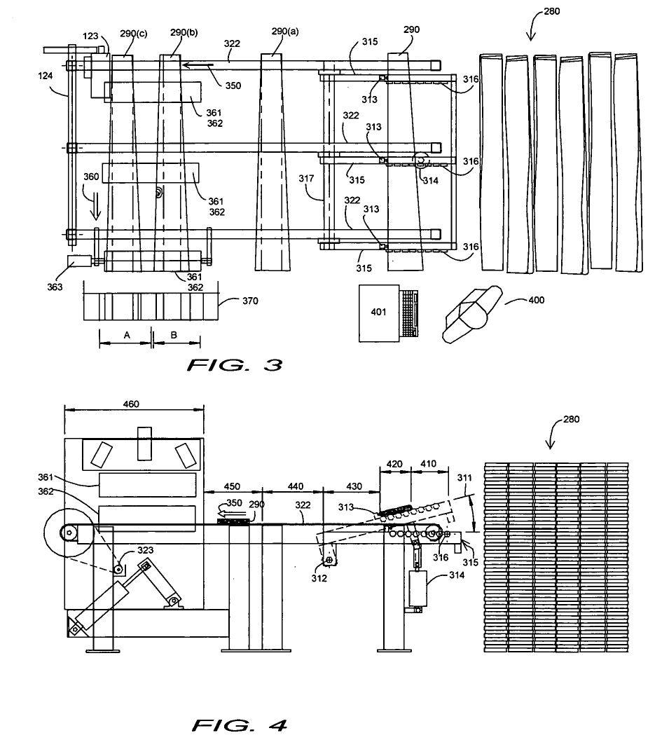

Referring now to the drawings, in particular to FIGS. 2, 3 and 4. FIG.2 is a perspective illustration, FIGS. 3 and 4 show top and side views respectively, of the automated infeed system constructed according to the principles of the present invention. Shown in the illustrations, an operator 400 removes a workpiece 290 from a supply pile 280 to a ramped roller structure 410, there-in-after, through a pick-up station 420, and continues through a width measuring station 430, projection and optimization area 440, clear area 450 and saw feeding area 460. Fixed arbor gang rip saws 370 are shown in the plan view of FIG. 3. Thus boards 290 to be processed progress from right to left 350 on rollers 316 and belts 322 until they reach the saw area 460. That is, as will be described in more detail shortly, the boards travel broadside in direction 350 until they are picked up by pinch-rollers 361 and 362 at which time they are fed lengthwise in direction 360 into the gang rip saw blades 170, with details of the pinch roller arrangement shown in side view in FIG. 7. The sawed boards are then transferred away from the sawing system for further processing.

It will be observed in FIG. 3 that the transfer of boards from loading station 410 to the saw area 460 is accomplished by means of a series of pivoting roller tracks 315 coupled by tie-bar 319 of which 3 sets are shown for purposes of illustration. The number and spacing of tracks 315 and belts 322 is not fixed but depends on such parameters as the board lengths to be processed, available floor space, etc. By way of example, six sets of roller tracks and belts may be used, spaced apart at three-foot intervals. In such a setup, boards as long as 18 feet may be processed.

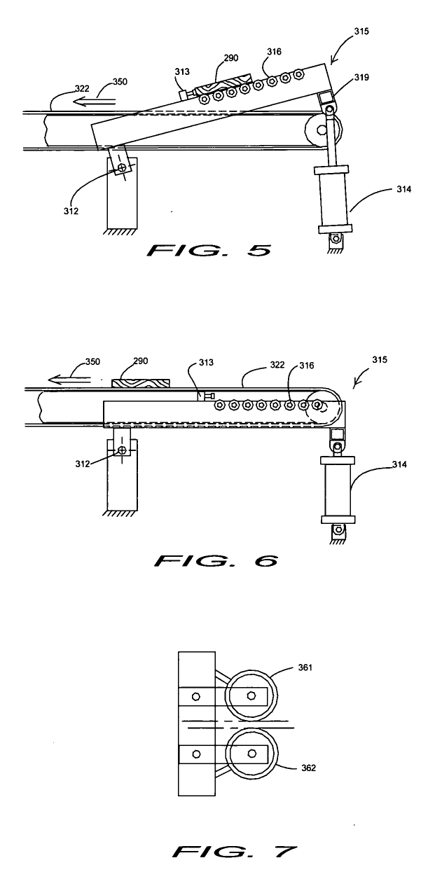

Considering now in more detail the operation of the auto infeed system of the present invention, boards 290 are input at load station 410 on a pivoted roller structure. Shown in FIGS. 3, 4, 5 and 6, an operator 400 removes a workpiece 290 from a supply pile 280 to an inclined roller structure 315. The roller structure has a fulcrum end 312 and a movable end 311, this is best illustrated in FIGS. 5 and 6. The roller structure is in a normally ramped stance, positioned by an extended linear actuator 314. The workpiece slides on a plurality of rollers 316, assisted by gravity, while aligning itself against mechanical steps 313. The linear actuator 314 is retracted to a horizontal position so that the workpiece rests on a parallel series of first belt conveyors 322 and released as mechanical stops are lowered, by pivoting roller conveyor 315, below the top driving surfaces of conveyor belts 322, subsequently releasing the workpiece onto a parallel series of first conveyors 322 for processing.

The advancing board is picked up simultaneously by belts 322 which is driven in the direction of 350. The belts are driven by a single servo motor 123 which is connected to a shaft 123 that is common to all the belts. Such mechanical connections are well known in the art and as they are not significant to the invention are not described here in detail.

The pivoting of roller conveyor 315 and belts 322 are commanded from an operator controlled console 401 shown in FIG. 3. The inner surface (opposite to the surface contacting the wood pieces) of the belts have teeth to engage sprockets on the shaft 124, to allow for precise movement of the boards. The belt teeth are preferably composed of polyurethane. On the opposite side of the belt, a high degree of friction is required between the belt and boards a rubber material is preferred, such as Linatex (M) rubber.

After leaving stops 313, a selected wood piece is smoothly accelerated by the belt system past a sensor area 430, where the board width is measured accurately by means of, for examply, a thru-beam type of optical sensor, coupled with position feedback operation from the servo motor driving the belts. One such sensor is the Omron (TM) model E3S-AT91.

As the board 290(a) is smoothly accelerated and then decelerated toward projection area 440, the measured width of the board is compared with all possible rip patterns, for example fifty such patterns, that are stored in the computer memory of console 401 and which correspond to the existing arbor gang saw configuration 370. For purposes of illustration, gang saw 370 is comprised of nine blades which are spaced arbitrarily. It will be appreciated that many different combinations of rip patterns can be achieved with the given blades. Only two simple patterns (A) and (B) are presented here as shown in FIG. 3. Thus, when board 290(a) arrives at projection area 440, the board is automatically and accurately positioned under a series of projected lines that represent the current arbor configuration, presenting the operator with a calculated optimum rip combination based on the measured width.

Assuming, for example, board 290(c) is automatically positioned for the optimum pattern (A) that will result in maximum yield (i.e., least scrap) as shown in FIG. 3, and the operator accepts it as such, he presses a control on console 401, and the belts then move and position the board in front of the rip saw keeping it in the same relative position and orientation. Three sets of two pinch rollers 361 and 362, which are actuated by pistons (not shown) then capture the board and feed it into the gang rip saw 370. In a preferred embodiment, the top pinch rollers are driven by the pistons against the board which is in turn driven against the bottom pinch rollers, and then the pinch rollers nearest the saw are driven by motor 363 to advance the board into the saw. It will be understood by those skilled in the art that the bottom pinch rollers may instead be driven to capture the board, or alternately that both the bottom and top pinch rollers may be driven.

The actual rip pattern (A) is shown to the operator by means of visible projected lines on the board at the projection area 440 (and on the computer screen at console 401, though the operator would typically rely on the projected pattern). Various systems known in the woodworking industry may be used to project lines on the boards, such as a shadowbox ( in which a bright light is projected against a series of strings to create line shadows) or a laser system having one laser per line. A preferred laser unit is Lumber Line Lasers by John McCormick & Sons.

For each board, the operator is able to choose from many alternate rip patterns. For example, if a different pattern (B) appears preferable to the operator, perhaps to avoid ripping through a knot which would have resulted from using pattern (A), then he can choose that pattern and direct the system to align the board and present it to the saw accordingly as board 290(b) with pattern (B) in FIG. 3. The computer will at the same time post the calculated yield on the screen for that particular pattern. The operator can, by manipulating the board by hand, or by turning a venire knob on console 401 fine tune the positioning of the board.

In one key aspect of the invention, the operator may also manually skew the board at an angle other than perpendicular to the belts to, for example, avoid a knot or split in the board. Once the desired rip pattern and skew are determined, the operator advances the board to area 460 for pick-up by the pinch rollers 361 and 362. The friction belts 322 maintain the skew angle, and smoothly position the board for the desired rip pattern. This is in contrast to the related art systems which use a fence (thus providing for perpendicular orientations only) or a complex arrangement of alignment pins.

For each board 290, therefore, two moves are commanded by the automated infeed system. The first move positions the visible board 290(a) at the projection area 440 to show the operator the computer solution for the optimum yield. The second move posiitons the same board 290(b) in the pinch rollers 361 and 362 to match the arbor configuration with the chosen pattern.

It will be appreciated by those skilled in the art how several important attributes of the present invention add to its simplicity. Firstly, given the sequence of operation, the use of a two position roller structure, pivoted by a linear actuator to a first load position, such that a board 290 placed on it will slide roll (assisted by gravity) squaring against stops, and then pivoted to a second position to release the board to a first belt conveyor. The use of the two position roller conveyor is ergonomically designed for an operator to single handedly load the boards 290 from a supply pile 280 and to control the automatic infeed operation. Secondly, by the use of an industrial servo motor 123 which quickly and accurately positions the boards on the disclosed auto infeed system. In the preferred embodiment, the servomotor is a Kollmorgen # M605D-A. The servo motor allows the disclosed system to feed the rip saw without using a fence, as noted above. This allows lumber to be fed in any orientation resulting in increased yield.

The control system of console 401 shown in FIG. 4 is typically a microprocessor based system having software developed specifically for the real time control of the apparatus of the present invention. Such control systems are commercially available and need not be described in detail. The control of mechanical systems is typically accomplished through digital to analog converters, of through direct digital digital-controlled servoactuators. Other direct digital outputs, such as a shaft encoder for determining the position of the belt conveyor, may also be employed. Such control instrumentation, included within console 401 in FIG. 3 is all within the scope of the art and will not be further described.

Once the various measurements such as width and length of boards are received by the computer, the software program calculates useful parameters such as yield, lineal feed and board length. While processing lumber, the computer constantly displays the yield data for the board being processed as well as the entire batch of lumber. As stated herein, the width measurement is accomplished by means of a sensor and is recorded by a counter. The length may be determined by various means, as is known in the art, such as through the use of another roller (not shown), subjacent to the pinch roller 362, that is used to calculate the board length by counting roller rotations as the board is being fed to the gang rip saw.

Other parameters that are determined by the computer include the optimum use of the board based on current value of different board sizes. The value data for lumber can be periodically fed into the computer and used to optimize the desired cut. The operation of the automated infeed system disclosed in this invention is a fully integrated system comprising the computer, feed-back instrumentation on the floor, and the operator's console 401.

The invention offers advantages over the prior art in providing a low-cost, simplified method and apparatus for the loading and cutting of wood pieces using a gang rip saw, that provides additional flexibility in the manufacturing environment for optimizing yield. A wood piece is placed by hand onto a raised roller structure to slide to a stop located on a lower end of the roller structure. The roller structure is made up of a series of interconnected rectangular members disposed contiguous a matching series of friction belt conveyors that form the first conveyor. The roller structure has a pivot end and a movable end. Each rectangular member has a raised step member on its top surface proximate the pivot end for stopping the wood piece from advancing beyond the ramped roller structure. A linear actuator is used to raise and lower the movable end. Raising the moveable end forms a ramp, lowering releases the wood piece to the first conveyor. The sliding action is assisted by a linear array of roller bearings affixed to an upper edge of each of said rectangular members so that once a wood piece is placed on the ramp it will slide, assisted by gravity, in the direction on the first conveyor while squaring up against each raised step.

When the roller structure is lowered, the raised step member declines below the top surfaces of the moving friction belts forming the first conveyor. The workpiece is released and conveyed transversly past a scanner to determine its dimensional characteristics. The workpiece is then moved to a second conveyor to feed the workpiece to a saw.

While the invention has been particularly shown and described with reference to the preferred embodiments thereof, it will be understood by those skilled in the art that various changes in form and details may be made without departing from the spirit and scope of the invention.

What is claimed is:

1. An apparatus for feeding a saw, comprising:
a loading area where a workpiece is placed by hand onto a movable structure;
a first conveying means working in conjunction with a scanning means;
said scanning means determines dimensional characteristics of said workpiece, and
a second conveying means for feeding said workpice into said saw.

2. The apparatus of claim 1 wherein said workpiece is lowered to said first conveying means, said first conveying means conveys said workpiece past said scanning means while recording dimensional characteristics of said workpiece by computer, said workpiece is positioned in front of said saw based on recorded measurements, said workpiece is conveyed into said saw by said second conveying means.

3. The apparatus of claim 1 wherein said movable structure can be raised and lowered.

4. The apparatus of claim 1 wherein said first conveyor means comprises one or more belts or chains.

5. The apparatus of claim 1 wherein said second conveyor means comprises one or more pairs of pinch rollers.

6. The apparatus of claim 1 wherein said scanning means comprises one or more optical sensors working in conjunction with said first conveyor.

7. A method for a single operator to load and control the automatic infeeding of workpieces to a saw, comprising the steps of:
placing a first workpiece from a nearby supply and placing said workpiece onto a moveable structure;
said workpiece advances and squares up against a plurality of stop members;
providing control means for the operator to lower said movable structure for releasing said workpiece to said first conveying means thereupon, moving said workpiece transversely;
providing a scanning means for determining dimensional characteristics of said workpiece;
providing a second conveying means for feeding said workpiece into said saw.

8. The method of claim 7 wherein said control means enables an operator to lower said movable structure from a normally raised position to a lower position so that the raised stop member declines subjacent the top surfaces of said friction belts there-at conveying said workpiece transversely past said scanning means.

9. The method of claim 7 wherein said movable structure automatically restores to said raised position after lowering and releasing said workpiece to said first conveyor means.

10. The method of claim 7 wherein said workpiece is released to said first conveyor means, said dimensional characteristics of said workpiece are recorded by computer, said workpiece is positioned in front of said saw based on recorded dimensional characteristics, said workpiece is conveyed into said saw by said second conveying means.

11. The method of claim 7 wherein said second conveyor is comprised of one or more pairs of pinch rollers.

12. The method of claim 7 wherein said scanning means is composed of one or more optical sensors working in conjunction with said first conveyor.

13. The method of claim 9 wherein the operator control of lowering said movable structure to release said workpiece for automatic infeeding to a saw enhances the operation by making it safer, ergonomically beneficial, and cost efficient for a single operator to operate the saw infeed system.

14. A method for a single operator to load and control the automatic infeeding of workpieces to a saw, comprising the steps of:
placing a first workpiece from a nearby supply and placing said workpiece onto a movable ramp structure;
said workpiece advances and squares up against a plurality of stop members;
providing control means for the operator to lower said ramp structure for releasing said workpiece to said first conveying means thereupon, moving said workpiece transversely;
providing a scanning means for determining dimensional characteristics of said workpiece;
providing a second conveying means for feeding said workpiece into said saw.

15. The method of claim 14 wherein said moveable ramp structure comprises a plurality of moveable ramp structures arranged in parallel and adjacent to a matching plurality of spaced friction belts forming said first conveyor means to support said workpieces.

16. The method of claim 14 wherein said control means enables an operator to lower said movable ramp structure from a normally raised position to a lower position so that the raised stop member declines subjacent the top surfaces of said friction belts there-at conveying said workpiece transversely past said scanning means.

17. The method of claim 14 wherein said movable ramp structure automatically restores to a raised position after releasing said workpiece to said first conveyor means.

18. The method of claim 14 wherein said workpiece is released to said first conveyor means, said dimensional characteristics of said workpiece are recorded by computer, said workpiece is positioned in front of said saw based on recorded dimensional characteristics, said workpiece is conveyed into said saw by said second conveying means.

19. The method of claim 14 wherein said second conveyor is comprised of one or more pairs of pinch rollers.

20. The method of claim 14 wherein said scanning means is composed of one or more optical sensors working in conjunction with said first conveyor.

21. The method of claim 14 wherein the operator control of lowering said movable structure to release said workpiece for automatic infeeding to a saw enhances the operation by making it safer, ergonomically beneficial, and cost efficient for a single operator to operate the saw infeed system.
